(19) United States
(12) Patent Application Publication
(10) Pub. No.: US 2008/0206605 A1
(43) Pub. Date: Aug. 28, 2008

(54) Current collector for fuel cell systems

(75) Inventors: Martin Perry, Sunnyvale, CA (US); Matthias Gottmann, Sunnyvale, CA (US)

Correspondence Address: FOLEY AND LARDNER LLP;SUITE 500, 3000 K STREET NW, WASHINGTON, DC, 20007, US

(73) Assignee: Bloom Energy Corporation

(21) Appl. No.: 11/711,625

(22) Filed: Feb. 28, 2007

(51) Int. Cl. H01M 8/00

(52) U.S. Cl. 429/12

(57) ABSTRACT

A current collector for a fuel cell stack includes a first member configured for coupling to a fuel cell stack, the first member comprising a generally planar portion and a tubular portion having an open end. The current collector also includes a flexible member coupled to the first member. At least a portion of the flexible member is received in the open end of the tubular portion and the first member and the flexible member provide a conductive path for current generated by the fuel cell stack.

### BACKGROUND

The present invention relates generally to the field of fuel cell systems, and in particular, to current collectors for use with such systems.

Fuel cells are electrochemical devices which generate electricity using an external supply of fuel (e.g., hydrogen, hydrocarbon, alcohols, etc.) and an oxidant (e.g., oxygen, air, etc.) that react in the presence of an electrolyte. One example of such a fuel cell utilizes hydrogen as a fuel source and an oxygen containing gas (e.g., air) as an oxidant. The fuel cell generates electricity through an electrochemical reaction between the fuel and oxidant.

In a high temperature fuel cell system (e.g., solid oxide and molten carbonate fuel cell systems, etc.), an oxidizing flow is passed through the cathode side of the fuel cell while a fuel flow is passed through the anode side of the fuel cell. The oxidizing flow is typically air, while the fuel flow is typically a hydrogen-rich gas created by reforming a hydrocarbon fuel source, such as natural gas or methane. The fuel cell, operating at a temperature of between approximately 700° C. and 1000° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit.

Fuel cell stacks typically include one or more current collectors or power leads that provide a path for electrical current to flow from inside a hot zone (also called “hot box”) to a cold zone, where the current collectors are connected to terminal blocks or to power conditioning equipment. The current collectors are generally formed as solid rods that are made from a high temperature super alloy material (e.g., Inconel 600) that is capable of withstanding the high temperatures that exist in the hot zone.

The materials used to form conventional current collectors or power leads typically have relatively high mechanical stiffness. Because the leads are rigidly connected to the fuel cell stacks and must have a length sufficient to reach through the thermal insulation package provided in the fuel cell stack (e.g., between approximately 15 cm and 50 cm), the leads may generate relatively large bending moments at or near their attachment point at the fuel cell stack. These bending moments may exceed the strength of the stack components and result in damage thereto.

Accordingly, it would be desirable to provide an improved fuel cell power lead or current collector that is capable of withstanding relatively high temperatures and that is less likely to cause mechanical damage to the fuel cell. It would also be desirable to provide a current collector that requires lower labor costs to install than conventional current collectors. It would be advantageous to provide such a power lead or current collector having one or more of these or other advantageous features as will be apparent to those reviewing the present disclosure.

### SUMMARY

An exemplary embodiment relates to a current collector for a fuel cell stack that includes a first member configured for coupling to a fuel cell stack, the first member comprising a generally planar portion and a tubular portion having an open end. The current collector also includes a flexible member coupled to the first member. At least a portion of the flexible member is received in the open end of the tubular portion and the first member and the flexible member provide a conductive path for current generated by the fuel cell stack.

Another exemplary embodiment relates to a power lead for a fuel cell system that includes a flexible cable and a member configured for coupling to a fuel cell stack. The member including an opening for receiving the flexible cable and a portion of the flexible cable is provided in the opening and welded to the member.

Another exemplary embodiment relates to a fuel cell system that includes a fuel cell stack and a current collector comprising a first portion coupled to the fuel cell stack and a flexible cable coupled to and extending from the first portion, the current collector providing a conductive path for electrical current.

### BRIEF DESCRIPTION OF THE DRAWINGS

FIG. 1 is a schematic diagram of a fuel cell stack according to an exemplary embodiment.

FIG. 2 is a photograph illustrating a current collector according to an exemplary embodiment.

FIGS. 3-5 are photographs illustrating a current collector coupled to a fuel cell stack according to an exemplary embodiment.

FIG. 4 is a scanning electron micrograph illustrating the formation of an oxide layer on strands of a braided wire of a current collector such as that shown in FIG. 2.

### DETAILED DESCRIPTION

According to an exemplary embodiment, a current collector or power lead configured for use with fuel cell systems is provided that includes a relatively flexible member or element (e.g., a braided strand of conductive metal wires). The flexible member provides a current path for the fuel cell stack without producing a relatively large bending moment that may damage components of the fuel cell stack to which it is connected.

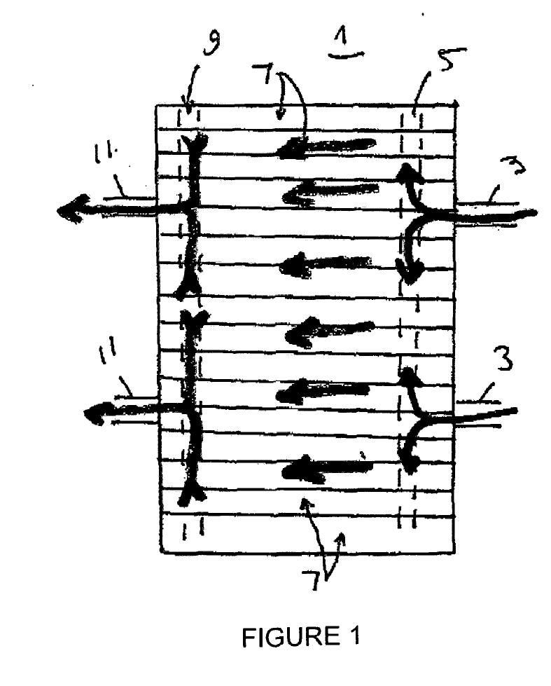

FIG. 1 is a schematic illustration of a fuel cell stack 1 according to an exemplary embodiment. The fuel cell stack 1 includes a plurality of fuel delivery or inlet ports 3. While two ports 3 are shown in FIG. 1, it should be understood that more than two ports 3 (e.g., three to ten ports, etc.) may be provided. The fuel provided through the ports 3 circulates through fuel inlet riser openings 5 into the fuel cells 7 and then exits the fuel cells 7 through fuel outlet riser openings 9. The fuel exhaust is provided into fuel outlet ports 11 from the outlet riser openings 9. Preferably, the stack 1 contains a plurality of fuel outlet ports 11, such as two or more such ports.

Each of the plurality of fuel delivery ports 3 is positioned in the fuel cell stack 1 to provide fuel to a portion of the plurality fuel cells 7 in or on each stack. In other words, the fuel delivery ports 3 may be located “on” the stack 1 by being connected to fuel manifolds which are located between the fuel cells or the fuel delivery ports 3 may be located “in” the stack 1 by being directly connected to fuel inlet riser openings 5 in the stack 5. Exemplary plate shaped fuel manifolds which are located in the stack are described in U.S. application Ser. No. 11/276,717, which is incorporated herein by reference in its entirety. The fuel from each fuel delivery port 3 is preferably provided to less than all fuel cells 7 in the stack 1. However, it should be noted that the term “provide fuel to a portion of the plurality fuel cells” does not necessarily exclude allowing the fuel from a particular port 3 from circulating through the entire stack 1, with the other port(s) 3 providing supplemental fuel in other portions of the stack 1.

According to an exemplary embodiment, the stack 1 is internally manifolded for fuel. Thus, fuel is distributed to each fuel cell 7 using riser openings 5, 9 contained within the stack 1. Alternatively, the stack may be externally or semi-internally (i.e., containing only an inlet riser opening) manifolded for fuel. The stack 1 may be internally or externally manifolded for oxidizer, such as air. According to an exemplary embodiment, the stack 1 is externally manifolded for oxidizer. Thus, the stack 1 is open on the air inlet and outlet sides, and the air is introduced and collected independently of the stack hardware.

The stack 1 may have any suitable shape according to various exemplary embodiments. According to a particular exemplary embodiment, the stack 1 is a planar type stack containing plate shaped (i.e., planar) fuel cells 7 such as those shown in FIG. 1. The stack may be positioned in any suitable orientation from vertical to horizontal. According to a particular exemplary embodiment, the stack is positioned vertically, with each fuel cell being located over the adjacent fuel cell below. The fuel delivery ports 3 and the fuel outlet ports 11 may be positioned periodically up the stack 1, as shown in FIG. 1.

According to an exemplary embodiment, the fuel cells 7 are high temperature fuel cells such as solid oxide fuel cells or molten carbonate fuel cells. According to other exemplary embodiments, other types of fuel cells may be utilized (e.g., fuel cells that use hydrogen and/or hydrocarbon (e.g., methane or natural gas) fuels).

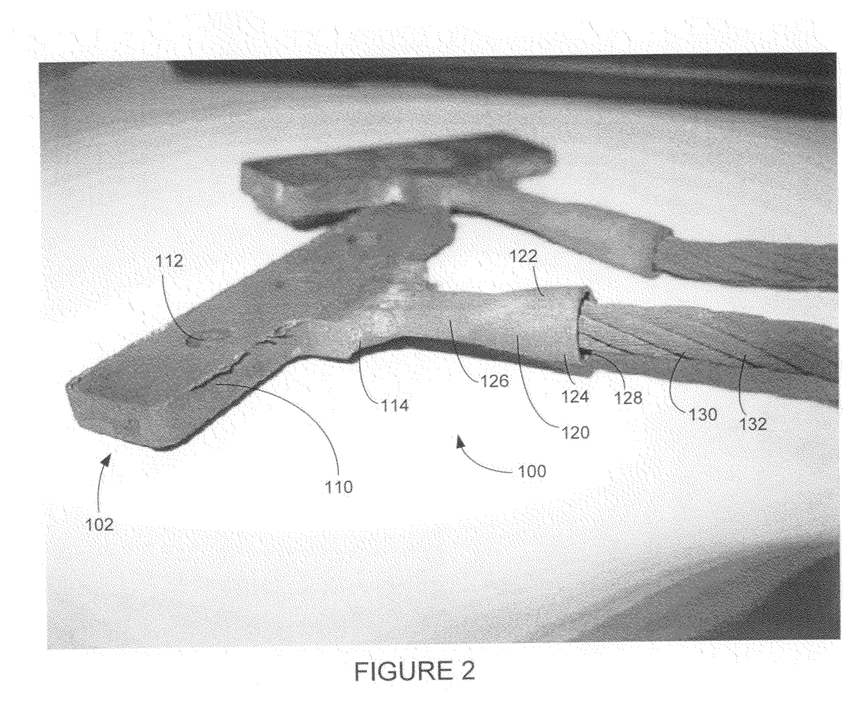

FIG. 2 illustrates a current collector or power lead 100 for use with a fuel cell system such as that shown in FIG. 1 according to an exemplary embodiment. The current collector 100 is made of a conductive material and is configured to provide a path for electrical current to flow from inside a hot zone of the fuel cell system (also referred to as a “hot box”) to a cold zone, where the current collector is connected to terminal blocks or to power conditioning equipment.

According to an exemplary embodiment, the current collector 100 includes a rigid portion 110 at a terminal or distal end 102 of the current collector 100 that is configured for coupling to the fuel cell stack. As shown in FIG. 2, the portion 110 is generally flat or planar. The portion 110 may be mechanically and electrically connected to the end plate of the stack 1. For example, the portion 110 may be welded to the stack end plate. Alternatively, the portion 110 may be bolted to the stack end plate. For example, portion 110 includes three apertures or holes 112 for receiving bolts or other fasteners (not shown) therethrough to secure the current collector 100 to the fuel cell stack. While FIG. 2 shows the planar portion 110 as having a generally rectangular shape, it should be understood that according to other exemplary embodiments, the planar portion 110 may have any of a variety of other shapes (e.g., square, circular, etc.). For example, portion 110 may comprise a lug ring instead of a planar portion. Further, the size (e.g., thickness, area, etc.) and configuration may vary according to other exemplary embodiments. For example, a different number of holes may be provided in the portion 110 or the portion may not include any holes.

The portion 110 includes an extension or protrusion 114 that extends from the portion 110. The extension 114 may be integrally formed with the portion 110 or may be produced separately and coupled (e.g., welded) to the portion 110. The size, shape, and/or configuration of the extension 114 may vary according to other exemplary embodiments.

A member or element 120 having a generally hollow tubular portion 122 (i.e., a tube) is coupled to the extension 114. The member 120 may be integrally formed with the extension 114 or may be produced separately and coupled (e.g., welded) to the member 114. According to another exemplary embodiment, the member 120 may be coupled directly to the portion 110 of the current collector.

As shown in FIG. 2, the member 120 tapers from an open first end 124 to a second end 126 provided proximate the member 114. The first end includes a generally circular opening 128. The size, shape, and/or configuration of the member 120 may vary according to other exemplary embodiments. For example, the opening provided at the distal end of the member 120 may have a generally square, oval, rectangular, triangular, or other shape.

A flexible member or element 130 (e.g., a cable, wire, etc.) is received within the opening 128 formed in the distal end 124 of the member 120. According to an exemplary embodiment, the flexible member is formed from a generally conductive material (e.g., a high temperature metal alloy) and is configured to provide a reliable electron conduction path for the fuel cell stack. According to an exemplary embodiment, the flexible member 130 is provided in the form of a braided wire that comprises a plurality of individual wires 132 that are wrapped together to form the flexible member 130. According to an exemplary embodiment, the individual wires have a diameter of between approximately 0.05 mm and 1 mm and the flexible member 130 has a diameter of between approximately 2 mm and 10 mm.

To couple the flexible member 130 to the member 120, an end of the flexible member 130 is inserted into the open end 124 of the member 120 and coupled or secured to the member 120 using any suitable method. According to an exemplary embodiment, the flexible member 130 is welded or brazed to the member 120 using any welding or brazing method suitable for use with high temperature alloys. Welding the flexible member 130 to the member 120 provides a reliable electron conduction path and sufficient pull strength such that the flexible member 130 cannot easily be pulled from the member 120. One advantageous feature of the configuration illustrated in FIG. 2 is that the hollow portion of the member 120 protects the weld joint with the flexible member from experiencing bending forces that may damage the weld joint.

By using the flexible member 130 in place of a solid rod extending from the current collector, issues associated with the stiffness of the solid rods (e.g., damage to the fuel cell stacks as a result of the relatively large bending moments of the rods, which are made from a relatively stiff high temperature alloy) may be avoided. The flexible member 130 provides enhanced flexibility as compared to the rods while still providing an adequate conduction path for electrical current generated by the fuel cell stack. Further, the member 120 allows for any bending motion to be moved away from the location where the current collector 100 meets the stack and into the bulk of the braid flexible member 130. As a result, the current collector can be made longer (e.g., between 50 and 100 percent longer) than conventional rigid current collectors.

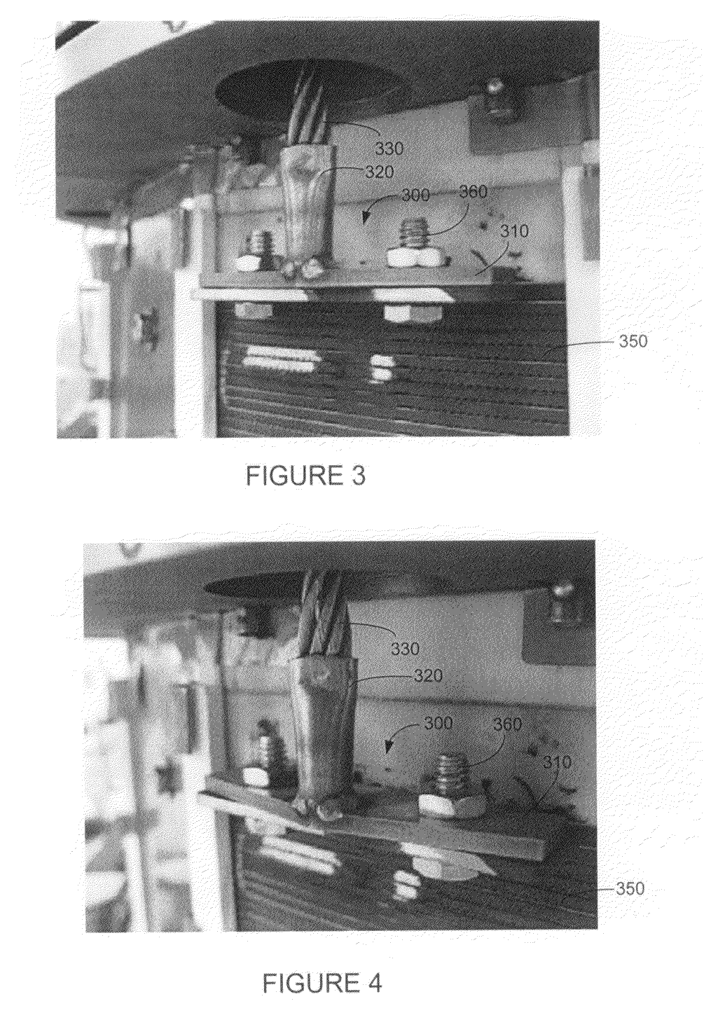

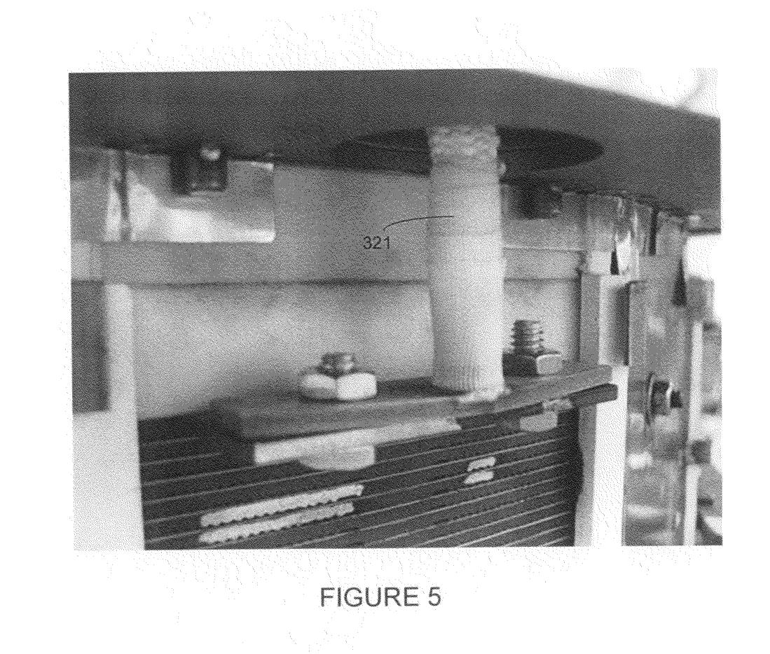

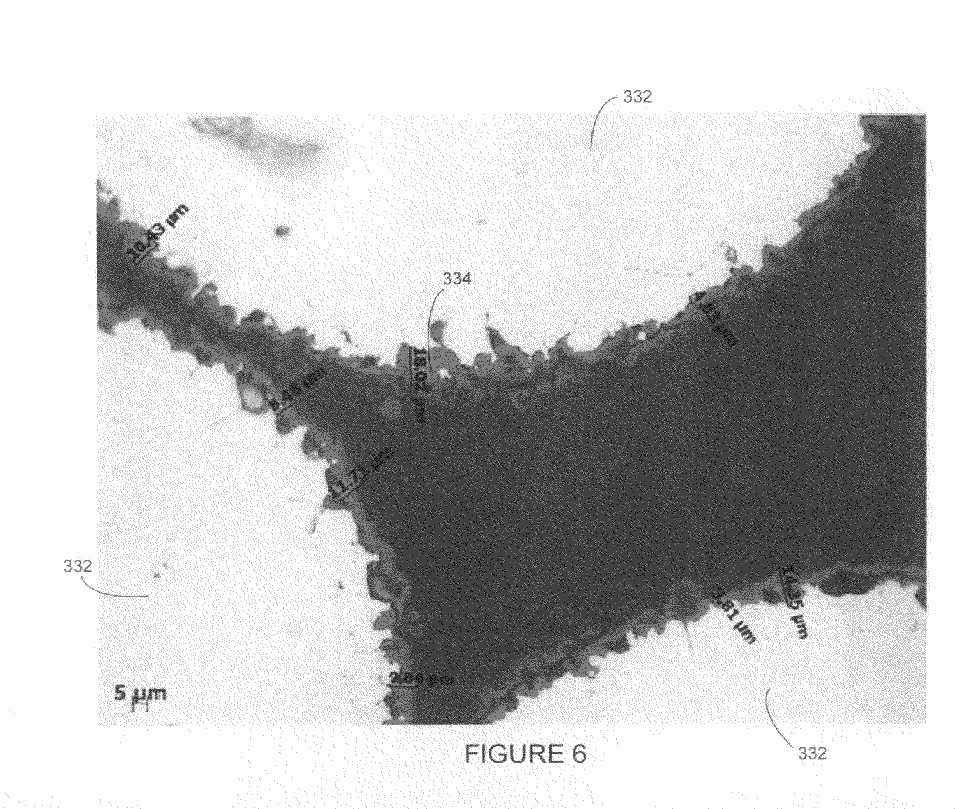

FIGS. 3-5 illustrate the coupling of a current collector 300 to a fuel cell stack 350. The current collector 300 includes a rigid portion 310 at a terminal or distal end of the current collector 300 that is configured for coupling to the fuel cell stack, member or element 320 having a generally hollow tubular portion (i.e., a tube), and a flexible member or element 330 (e.g., a cable, wire, etc.) received within the opening formed in the distal end of the member 320. The current collector shown in FIGS. 3-5 is similar to that shown in FIG. 2 except that the member 320 is welded at substantially a right angle to a major surface to the planar portion 310 rather than to an edge surface of the planar portion 310. The portion 310 is mechanically and electrically connected to the end plate of the stack 350 using fasteners 360, such as bolts and nuts. Additionally, as shown in FIG. 5, a member or element 321 in the form of a sheath or wrap is provided around the member 320 and the flexible member 330 to provide thermal and/or electrical insulation for the members.

The components of the current collector 100 are made from materials that are capable of withstanding temperatures that are present in a high temperature fuel stack (e.g., between approximately 700° C. and 1000° C.). Suitable materials include high temperature super alloys such as Inconel 600 or 625. According to other exemplary embodiments, other materials may be used. According to one such embodiment, a nickel-chromium-aluminum-iron alloy may be used such as that commercially available from Haynes International of Kokomo, Ind. under the trade name Haynes® 214™ (nominal composition by weight: 75 percent nickel, 16 percent chromium, 4.5 percent aluminum, 3 percent iron, up to 0.5 percent manganese, up to 0.2 percent silicon, up to 0.1 percent zirconium, 0.05 percent carbon, up to 0.01 percent boron, and 0.01 percent yttrium). According to another embodiment, a nickel-chromium-tungsten-molybdenum alloy may be used such as that commercially available from Haynes International under the trade name Haynes® 230™ (nominal composition by weight: 57 percent nickel, 22 percent chromium, 14 percent tungsten, 2 percent molybdenum, up to 3 percent iron, up to 5 percent cobalt, 0.5 percent manganese, 0.4 percent silicon, 0.3 percent aluminum, 0.1 percent carbon, 0.02 percent lanthanum, and up to 0.015 percent boron). According to other exemplary embodiments, the current collector may be made from any other suitable material, including any 600, 700, or 800 series Inconel alloy.

According to an exemplary embodiment, the portion 110, extension 114, and member 120 are formed from the same material (e.g., Inconel). According to other exemplary embodiments, one or more of such components may be made from a different material than the others.

According to an exemplary embodiment, the flexible member 130 is formed as a braided strand of wires formed from a nickel-chromium-iron alloy (e.g., Inconel 625). According to other exemplary embodiments, the flexible member may use wires formed from other materials, such as those described above with respect to the current collector (e.g., a nickel-chromium-aluminum-iron alloy, a nickel-chromium-tungsten-molybdenum alloy, or any suitable 600, 700, or 800 series Inconel alloy).

The inventors have shown that flexible members such as those shown in FIG. 2 are capable of withstanding the high temperature environment that would be expected in a high temperature fuel cell stack for thousands of hours. FIG. 6 is a scanning electron micrograph illustrating a cross-section of braided wires 332 (e.g., similar to wires 132 shown in FIG. 2) formed of Inconel 625 and subjected to temperatures of approximately 850° C. for approximately 2700 hours. As shown in the micrograph, only very thin layers of oxide 334 were formed during this time.

The current collector 100 shown and described herein advantageously provides improved system reliability for the fuel cell stacks (e.g., by reducing the tendency for the current collector to damage the stack) and ease of handling during assembly due to the flexibility of the braided wires. The ease of handling reduces the labor cost associated with producing the fuel cell stacks.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is important to note that the construction and arrangement of the current collector as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present inventions as expressed in the appended claims.

What is claimed is:

1. A current collector for a fuel cell stack comprising:
a first member configured for coupling to a fuel cell stack, the first member comprising a generally planar portion and a tubular portion having an open end; and
a flexible member coupled to the first member, at least a portion of the flexible member received in the open end of the tubular portion;
wherein the first member and the flexible member provide a conductive path for current generated by the fuel cell stack.

2. The current collector of claim 1, wherein the first member comprises at least one aperture configured to receive a fastener for coupling the first member to the fuel cell stack.

3. The current collector of claim 1, wherein the flexible member is coupled to the first member by a weld.

4. The current collector of claim 1, wherein the first member and the flexible member are formed from high temperature metal alloys.

5. The current collector of claim 1, wherein the first member is formed from a material selected from the group consisting of Inconel alloys, and the flexible member is formed from a material selected from the group consisting of Inconel alloys.

6. The current collector of claim 1, wherein the flexible member comprises a braided strand of wires.

7. The current collector of claim 1, wherein at least one of the first member and the flexible member are formed of a material selected from the group consisting of a nickel-chromium-aluminum-iron alloy and a nickel-chromium-tungsten-molybdenum alloy.

8. A power lead for a fuel cell system comprising:
a flexible cable; and
a member configured for coupling to a fuel cell stack, the member including an opening for receiving the flexible cable;
wherein a portion of the flexible cable is provided in the opening and connected to the member.

9. The power lead of claim 8, wherein the member comprises a generally planar portion having a plurality of apertures provided therein for coupling the member to a fuel cell stack.

10. The power lead of claim 8, wherein the flexible cable and the member are formed of an electrically conductive high temperature metal alloy.

11. The power lead of claim 8, wherein the flexible cable is a braided strand of wires.

12. The power lead of claim 8, wherein the portion of the flexible cable is connected to the member by a weld in the opening.

13. The power lead of claim 8, wherein at least one of the flexible cable and the member configured for coupling to a fuel cell stack comprise a material selected from the group consisting of an Inconel alloy, a nickel-chromium-aluminum-iron alloy, a nickel-chromium-tungsten-molybdenum alloy, and combinations thereof.

14. A fuel cell system comprising:
a fuel cell stack; and
a current collector comprising a first portion coupled to the fuel cell stack and a flexible cable coupled to and extending from the first portion, the current collector providing a conductive path for electrical current.

15. The fuel cell system of claim 14, wherein the fuel cell stack comprises a plurality of high temperature fuel cells.

16. The fuel cell system of claim 15, wherein the fuel cells are selected from solid oxide fuel cells and molten carbonate fuel cells.

17. The fuel cell system of claim 14, wherein the flexible cable is coupled to the first portion by a weld.

18. The fuel cell system of claim 14, wherein the first portion comprises a planar member and a hollow member coupled to the planar member, and wherein a portion of the flexible cable is received within the hollow member.

19. The fuel cell system of claim 18, wherein the hollow member provides for any bending motion to be moved away from the location where the planar member is connected to the fuel cell stack and into a bulk of the flexible cable.

20. The fuel cell system of claim 18, wherein the planar member comprises at least one aperture for facilitating the coupling of the first portion to the fuel cell stack.

21. The fuel cell system of claim 18, wherein the planar member comprises at least one aperture for facilitating the coupling of the first portion to the fuel cell stack.

22. The fuel cell system of claim 14, wherein at least a portion of the current collector comprises a material selected from the group consisting of an Inconel alloy, a nickel-chromium-aluminum-iron alloy, a nickel-chromium-tungsten-molybdenum alloy, and combinations thereof.

23. The fuel cell system of claim 14, wherein the first portion is coupled to an end plate of the fuel cell stack in a hot zone of the system and a free end of the flexible cable is electrically connected to a terminal block or to power conditioning equipment outside the hot zone.
